(19) United States
(12) Patent Application Publication
(10) Pub. No.: US 2016/0092952 A1
(43) Pub. Date: Mar. 31, 2016

(54) Method and System for Managing Geospatial Deployment

(71) Applicants: Joseph Patrick Forbes, Sandringham (AU); Daniel Paul Flemming, Glen Iris (AU)

(72) Inventors: Joseph Patrick Forbes, Sandringham (AU); Daniel Paul Flemming, Glen Iris (AU)

(73) Assignee: RENDER NETWORKS PTY LTD, Windsor, Victoria (AU)

(21) Appl. No.: 14/442,960

(22) PCT Filed: Jan. 29, 2015
(86) PCT No.: PCT/AU15/00045

§ 371 Date: May 14, 2015

(30) Foreign Application Priority Data
Jan. 29, 2014 (AU) 2014200481

(51) Int. Cl. G06Q 30/06; H04W 16/22; G06Q 10/10; H04W 16/18

(52) U.S. Cl. CPC G06Q 30/0611; H04W 16/18; H04W 16/22; G06Q 10/1097

(57) ABSTRACT

A system for managing geospatial deployment is described and includes an input for receiving design data indicative of a design that is to be deployed; a fragmenter configured to fragment said design data into work items, each of said work items including one or more geospatially tagged tasks; an aggregator; an allocator; a scheduler; and a work order generator configured to generate geospatially tagged work orders according to said implementation schedule, each of said work orders being indicative of one or more of said jobs and of one of said parties so identified as fit to implement said respective one or more jobs and each of the work orders being suitable for transmitting to the party identified in the respective work order.

### RELATED APPLICATION

This application is based on and claims the benefit of the filing and priority dates of Australian patent application no. 2014200481 filed 29 Jan. 2014, the content of which as filed is incorporated herein by reference in its entirety.

### TECHNICAL FIELD

The present invention relates to a method and system for managing geospatial deployment (i.e. most commonly construction), in particular for the physical deployment of new assets (whether involving existing assets or otherwise), such as assets designed using a geographical information system (GIS), as is of particular but by no means exclusive application in geographically distributed construction projects that involve high numbers of individual but related tasks.

### BACKGROUND

There are currently a number of substantial telecommunications infrastructure construction projects, including Australia's National Broadband Network (NBN) and New Zealand's Ultra Fast Broadband project. Such projects are unusual—and challenging to manage—as they involve very high numbers of individual but related tasks that are geographically widely distributed and which also involve large extensions of existing pieces of infrastructure. These problems can lead to cost and time overruns, problems that heretofore have been inadequately addressed.

For example, one difficulty experienced in the construction of such large projects arises from the source data used in the creation of work orders (WOs). Traditionally WOs are created from a file received from, from example, a Telco Operator; the file fully details what is to be the content of the WO (e.g. “Service Activation required at 55 XYZ St, between 9 am and midnight, 14 February). In this instance, the scope, duration and timing of the WO are provided in a consistent format from which the WO can be created. However, a project such as the NBN operates contractually at the geographic region level and in effect outsources management at the work item (WI) level to individual construction contractors. Consequently, if the construction contractors choose to use Work Management Systems (WMSs), they must each determine the details to be included in their own WOs, leading to potential fragmentation of the project and the danger of miscommunication.

### SUMMARY OF THE INVENTION

According to first broad aspect of the invention, there is provided a system for designing or managing geospatial deployment, comprising:
an input for receiving design data indicative of a design (such as of a telecommunciations network) that is to be deployed (or constructed);
a fragmenter configured to fragment the design data into work items, each of the work items comprising one or more geospatially tagged tasks;
an aggregator configured to analyse the tasks and thereby identifying a type of each of the tasks, and to generate one or more geospatially tagged jobs each comprising one or more of the tasks such that each of the jobs comprises only tasks of like type;
an allocator configured to compare the jobs with a database of approved parties and characteristics of the respective parties, to identify for each of the jobs at least one of the approved parties that is fit to implement the respective jobs, and to allocate one or more of the jobs to one or more of the parties so identified;
a scheduler configured to determine an optimal implementation schedule of the jobs; and
a work order generator configured to generate geospatially tagged work orders according to said implementation schedule, each of said work orders being indicative of one or more of said jobs and of one of said parties so identified as fit to implement said respective one or more jobs and each of said work orders being suitable for transmitting to the party identified in the respective work order.

As mentioned above, the tasks, jobs and work orders are geospatially tagged, that is, include data indicative of the geographical location(s) of intended deployment of the respective task, job or work order.

Thus, the present invention provides a system (and method) that may be used in any suitable phase of the design or management of a geospatial deployment project, such as during preliminary design work (including the surveying, development, production and approval of a design), immediately prior to commencement of deployment or during physical deployment of material and labour. In each case, there are a number of dependency driven, related activities that may be planned—or actually conducted—according to the present invention; the results can be used, for example, to evaluate the characteristics and/or viability of a project or in the actual deployment of a project.

The work order generator may be configured to transmit each of the work orders to the party identified in the respective work order.

In one embodiment, the system comprises a releaser configured to transmit data to each of the parties identified in the work orders indicating that the respective work orders should be implemented.

In another embodiment, the characteristics of the parties include a productivity value for each task provided by the respective parties.

In an embodiment, the system comprises a progress monitor that receives implementation progress data from the parties identified in the work orders. The characteristics of the parties may include a productivity value for each task provided by the respective parties, in which case the progress monitor may determine productivity from the progress data for each of the parties identified in the work orders and update the productivity values. The allocator may be adapted to allocate or re-allocate one or more of the jobs based additionally on the implementation progress data.

In one embodiment, the scheduler determines the implementation schedule according to criteria that comprise any one or more of: job dependency, state of completion, and capacity of implementation parties. For example, the scheduler may determine or update the implementation schedule periodically based on implementation progress.

In one embodiment, the system includes or is configured to access an element-to-task database, and the fragmenter identifies elements of the design in the design data and determines the tasks from the elements and the element-to-task database.

In another embodiment, the aggregator identifies a type of each of the tasks according to criteria that comprise any one or more of: task location and task capability requirements.

In a certain embodiment, the aggregator generates the jobs such that each of the jobs once generated has an expected duration that can be accommodated by a predefined work period.

In one embodiment, the allocator allocates each of the jobs according to the one or more tasks constituting the respective jobs.

The system may include a geospatial output generator configured to receive job data indicative of one or more of the jobs or work order data indicative of one or more of the work orders, and to generate data adapted for output or display as a map or superimposed on a map.

In one embodiment, the system includes a variation generator controllable to add, delete and alter tasks (including amending the type of a task, the size of a task and geospatial information associated with a task). The variation generator is typically configured to respond to the addition, deletion or alteration of a particular task by correspondingly altering (such as in sequence and characteristics) any tasks associated with that particular task.

The system may include a jeopardy input for receiving jeopardy data indicative of one or more factors that jeopardize the ability of a specific task to be commenced, thereby identifying geospatially tasks for consideration by the scheduler. This enables the geospatial data handling ability of the system to integrate delays at the task level in the scheduling of the work.

In an embodiment, the system comprises a defect rectifier configured to receive defect identification data indicative of a defect in a specified asset, to identify which resource performed work on the specific asset (typically using the geospatial data held by the system), and to control the work order generator to generate one or more geospatially tagged defect rectification tasks adapted to remediate or correct the defect.

This allows the system to automatically allocate and release the one or more defect rectification tasks to the appropriate resource, typically the resource that carried out the work in which the defect occurred or arose. Hence, initial deployment and defect management may be managed consistently in an integrated fashion.

According to second broad aspect of the invention, there is provided a computer-implemented method of designing or managing geospatial deployment, comprising:
electronically inputting design data indicative of a design that is to be deployed;
electronically fragmenting the design data into work items, each of the work items comprising one or more geospatially tagged tasks;
electronically analysing the tasks and thereby identifying a type of each of the tasks;
electronically generating one or more geospatially tagged jobs each comprising one or more of the tasks such that each of the jobs comprises only tasks of like type;
electronically comparing the jobs with a database of approved parties and characteristics of the respective parties and identifying for each of the jobs at least one of the approved parties that is fit to implement the respective jobs;
electronically allocating one or more of the jobs to one or more of the parties so identified;
electronically determining an optimal implementation schedule of the jobs; and
electronically generating geospatially tagged work orders according to the implementation schedule, each of the work orders being indicative of one or more of the jobs and of one of the parties so identified as fit to implement the respective one or more jobs and each of the work orders being suitable for transmitting to the party identified in the respective work order.

The method may include electronically transmitting each of the work orders to the party identified in the respective work order.

In one embodiment, the method comprises transmitting data to each of the parties identified in the work orders indicating that the respective work orders should be implemented.

In one embodiment, the characteristics of the parties include a productivity value for each task provided by the respective parties.

In one embodiment, the method comprises electronically receiving implementation progress data from the parties identified in the work orders. The characteristics of the parties may include a productivity value for each task provided by the respective parties, and the method include determining productivity from the progress data for each of the parties identified in the work orders and updating the productivity values.

The method may include allocating or re-allocating one or more of the jobs based additionally on the implementation progress data.

In a certain embodiment, the method includes determining the implementation schedule according to criteria that comprise any one or more of: job dependency, state of completion, and capacity of implementation parties. The method may include determining or updating the implementation schedule periodically based on implementation progress.

In another embodiment, the method includes accessing an element-to-task database, identifying elements of the design in the design data and determining the tasks from the elements and the element-to-task database.

The method may include identifying a type of each of the tasks according to criteria that comprise any one or more of: task location and task capability requirements.

In one embodiment, the method includes generating the jobs such that each of the jobs once generated has an expected duration that can be accommodated by a predefined work period.

The method may include allocating each of the jobs according to the one or more tasks constituting the respective jobs.

The method may include generating data adapted for output or display as a map or superimposed on a map from job data indicative of one or more of the jobs or work order data indicative of one or more of the work orders.

In one embodiment, the method includes electronically adding, deleting or altering tasks (including amending the type of a task, the size of a task and geospatial information associated with a task) in response to user control. Typically, the method in such an embodiment includes responding to the addition, deletion or alteration of a particular task by automatically correspondingly altering (such as in sequence and characteristics) any tasks associated with that particular task.

The method may include electronically receiving jeopardy data indicative of one or more factors that jeopardize the ability of a specific task to be commenced, thereby identifying geospatially tasks for consideration in determining the optimal implementation schedule.

In an embodiment, the method includes receiving defect identification data indicative of a defect in a specified asset, identifying which resource performed work on the specific asset, and controlling the work order generator to generate one or more geospatially tagged defect rectification tasks adapted to remediate or correct the defect.

According to this aspect, there is also provided a computer-computer program product comprising instructions that when executed by one or processors controls a computing device to implement the method described above, and a computer-readable medium comprising (such as in non-volatile form) such a computer program product.

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention can be more clearly ascertained, embodiments will now be described, by way of example, with reference to the accompanying drawings, in which:

FIG. 1 is a schematic diagram of an embodiment of the present invention;

FIG. 2 is a schematic diagram of the controller and user interface of the system of FIG. 1;

FIG. 3 is a more detailed schematic diagram of the memory of the system of FIG. 1;

FIG. 4A is a more detailed schematic diagram of the controller and user interface of the system of FIG. 1;

FIG. 4B is a schematic diagram of an alternative processor of the system of FIG. 1;

FIG. 5 is an example of a design for use as input to the system of FIG. 1;

FIG. 6 is a schematic representation of the output of the scheduler of the system of FIG. 1;

FIG. 7 is a flow diagram of the operation of the system of FIG. 1;

FIG. 8 is an illustration of typical interactions between the system of FIG. 1 in use and outside entities;

FIG. 9 is a schematic data flow diagram for the operation of the system of FIG. 1;

FIG. 10 is an example of detailed work order data outputted by the system of FIG. 1; and

FIG. 11 is an example of geospatial work order data outputted by the system of FIG. 1.

### DETAILED DESCRIPTION

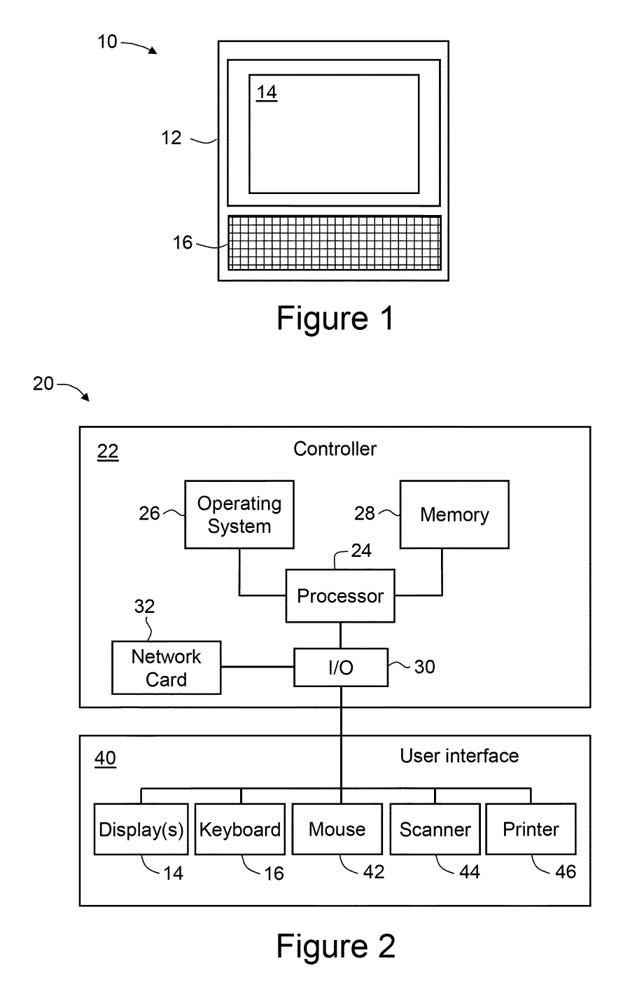

According to an embodiment of the present invention, there is provided a system for managing geospatial deployment, shown generally at 10 in FIG. 1. System 10 is implemented on a computing device 12 as a combination of software and hardware, and has a user interface that includes a display or displays 14 and a keyboard 16.

FIG. 2 is a more detailed, schematic block diagram 20 in which for clarity only the more important operative components of system 10 are shown. System 10 includes a controller 22 having a processor 24 and an operating system 26. Instructions and data to control operation of processor 24 are stored in a memory 28, which is in data communication with processor 24. Typically, system 10 includes both volatile and non-volatile memory and more than one of each type of memory, with such memories being collectively represented by memory 28.

System 10 has an input/output (I/O) interface 30 for communicating with peripheral devices of system 10. Input/output interface 30, the peripheral devices or both may be intelligent devices with their own memory for storing associated instructions and data for use with the input/output interface 30 or the peripheral devices.

System 10 includes a communications interface in the form of a network card 32. Network card 32 may be used, for example, to receive project information, commands and other data from a central controller, server or database, and to output results to that central controller, server or database.

In the embodiment shown in FIG. 2, system 10 includes a user interface 40 that includes peripheral devices that communicate with controller 22. These peripheral devices comprise the one or more displays 14, keyboard 16, a mouse 42, a scanner 44 and a printer 46. Additional hardware may be included as part of system 10, or hardware may be omitted as required for the specific implementation.

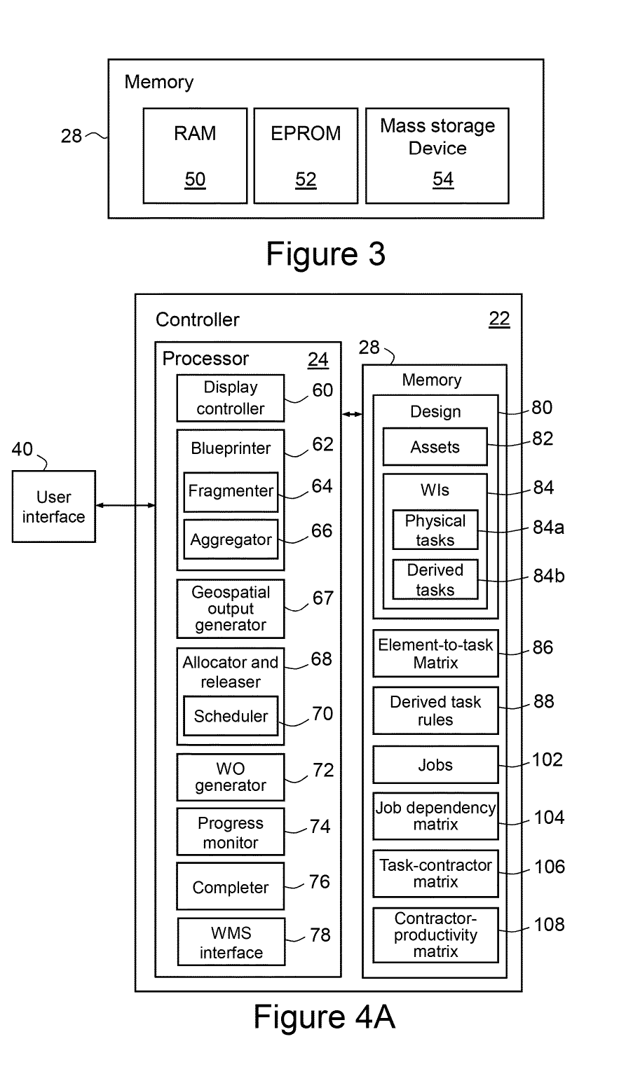

FIG. 3 shows a block diagram of the main components of memory 28. Memory 28 includes RAM 50, EPROM 52 and a mass storage device 54. RAM 50 typically temporarily holds program files for execution by processor 24 and related data. EPROM 52 may be a boot ROM device and contain system or program code. Mass storage device 54, which is typically in the form of a hard disk drive, stores programs, the integrity of which may be verified and/or authenticated by processor 24 using protected code from EPROM 52 or elsewhere. In this embodiment, mass storage device 54 also includes a feedback database 56 (whose content is discussed below).

It is also possible for the operative components of the system 10 to be distributed; for example, input/output devices 12, 14, 42 and 44 may be provided remotely from controller 22.

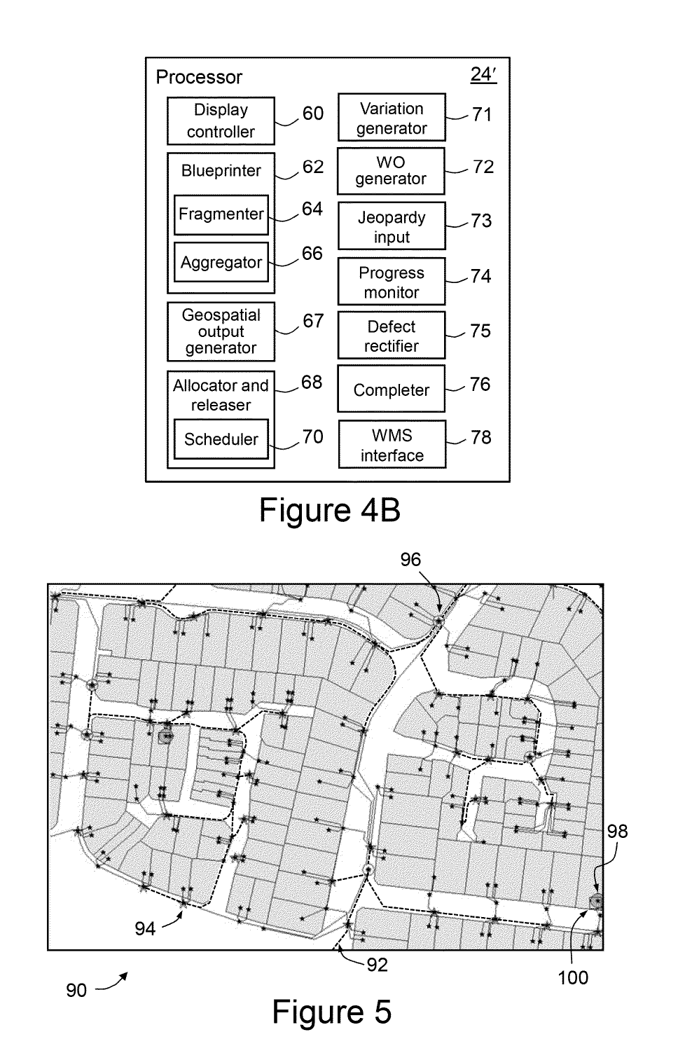

FIG. 4A is another schematic view of the user interface 40 and controller 22 of FIG. 3, with more detail shown in controller 22. Specifically, processor 24 of controller 22 includes a display controller 60 that controls the view that is displayed on display(s) 14. Processor 24 also includes a a blueprinter 62 (including a fragmenter 64 and an aggregator 66), a geospatial output generator 67, an allocator and releaser 68 (which has a scheduler 70), a WO (work order) generator 72, a progress monitor 74, a completer 76 and a WMS interface 78: the functions are these components are described below. It should be noted that, in some embodiments, the functions of allocator and releaser 68 are provided separately in an allocator component and a releaser component.

These components of system 10 geospatially optimise the management of the deployment of both services and materials required to deliver a project. They do so by maintaining the geospatial integrity and construction sequence of the design elements when carrying out the full lifecycle of the deployment.

Thus, a detailed project design in a spatial data format is provided to system 10 via network card 32 and stored in memory 28 as design 80, which includes a description of all the assets 82 included in the design. FIG. 5 is a portion of an exemplary design 90, in the form of the output of the FOND (trade mark) software of Biarri Networks Pty Ltd. In FIG. 5, land parcels/blocks are shown as shaded polygons. FOND has generated a telecommunications duct and pit network comprising existing and new components. The principal existing components (constituting a duct and pit network and/or a pole and aerial network) are shown with lines and small stars. Exemplary design 90 also includes:
12-fibre underground cables (dashed lines 92);
12-fibre splice joints or Thultiports' for splitting 12-fibre cables into 12 one-fibre cables (hollow stars 94);
72-, 144- or 288-fibre splice joints for connecting larger cables to a number of 12-fibre cables (circled stars 96);
72-, 144- or 288-fibre splice joints for connecting pairs of large cables (lightly shaded circles 98);
Fibre Distribution Hubs (FDHs) (squares 100), in exemplary design 90 each adjacent to a lightly shaded circle 98.

Blueprinter 62 then performs design fragmentation and aggregation, using its fragmenter 64 and aggregator 66. Fragmenter 64 receives design 80 from memory 28 and extracts assets 82 from design 80, from which fragmenter 64 determines Work Items (WIs) 84. The WIs 84 correspond to the items described in, typically, a Schedule of Rates (SoR) and Material Supply Agreements (or the like) that are used as the contractual frameworks to procure and secure resources to carry out the works on the project. Each WI 84 is also given or associated with a geospatial description, specifying where the respective WI 84 is to be performed, carried out, etc.; that description or association is retained throughout the operation of system 10 for the specific design 80. In addition, each WI 84 is linked to or associated with any predecessor WIs, that is, those that must be completed before the instant WI 84. For example, a cable splicing (i.e. joining cables) WI will require two or more cable hauling WIs to be completed beforehand. The WI/predecessor WI relationships are defined in an element-to-task matrix 86, discussed below.

The WIs 84 relate both to physical work to be carried out but also generally imply certain “Derived Services” that must also be carried out in order to deploy design 80. Hence, WIs 84 comprise two types of tasks: explicit tasks 84a, being physical tasks explicitly arising from physical tasks implied by specific assets 82, and derived tasks 84b that arise from the needs of implementing the explicit tasks 84a.

Thus, fragmenter 64 takes each asset 82 (in this example, a network element) in design 80 and creates one or more corresponding explicit tasks 84a. For example, the presence of an asset 82 in the form of a cable in design 80 prompts fragmenter 64 to create a cable hauling task 84a. To do this, memory 28 also includes an element-to-task matrix 86, which fragmenter 64 searches for assets 82 that it locates in design 80 and from which it reads the corresponding explicit task or tasks 84a. Indeed, some assets 82 in design 80 will imply plural tasks, such as an installation task and a testing task.

Such explicit tasks 84a, in the example of a project in which design 80 relates to the construction of an optical-fibre based telecommunications network (such as that shown in FIG. 5), the explicit tasks 84a may include:
1. CIVIL WORKS
   1.1. New Pole Installation
   1.2. PVC Pipe Supply & Underground Installation
      1.2.1. Open Trenching
      1.2.2. Directional Boring
   1.3. Pits/Manholes
      1.3.1. Pits/Manholes at New Locations in OTR (other than rock)
      1.3.2. Pits/Manholes at New Locations in Rock
   1.4. Surface Works
      1.4.1. Breakout Surface Materials
      1.4.2. Reinstatement of Surface Materials
2. CABLE INSTALLATION (UNDERGROUND)
   2.1. Pipe Proving
   2.2. Pipe Blockages
   2.3. Cable Hauling
3. CABLE INSTALLATION (AERIAL)
   3.1. Cable Installation Aerial in Power Corridor
      3.1.1. Pass Through Pole Installation with =<10 Degrees Deviation−Tether Cable Types/Multiport Tails
      3.1.2. Pass Through Pole Installation with =<10 Degrees Deviation−Ribbon Cable Types
4. FIBRE JOINT ENCLOSURE INSTALLATIONS AND FIBRE SPLICING
   4.1. Joint Enclosures
      4.1.1. Installation of Joint Enclosures
      4.1.2. Joint Enclosure Cable Preparation
   4.2. Fibre Distribution Cabinets (FDH)
   4.3. Multiport Installations
      4.3.1. Multiport Installations (Underground)
   4.4. Splicing
   4.5. Fibre Testing

Fragmenter 64 then takes the explicit tasks 84a and generates further “derived tasks” 84b, each of which fragmenter 64 associates with one or more particular explicit tasks 84a. The association between an explicit task and a derived task may arise, for example, because the explicit task and the derived task must be completed simultaneously, or because one must precede the other. A single explicit task may be associated by fragmenter 64 with one or more derived tasks, and vice versa. Some derived tasks are generated by fragmenter 64 based on spatial relationships. For example, an explicit task to be performed close to a major road will prompt fragmenter 64 to generate a derived task in the form of a traffic management task, associate the derived task with the explicit task, and tag that derived traffic management as to be performed simultaneously with the explicit task.

Memory 28 includes derived task rules 88, which fragmenter 64 employs to determine what derived tasks arise from any particular explicit task and what temporal relationship tag should be applied to the association created between any pair of explicit and derived tasks.

In the same example, the derived tasks 84b may include:
1. APPROVALS
   1.1. Land Access and Statutory Approvals
   1.2. Utility Infrastructure Access Approvals
2. PROJECT SUPERVISION
   2.1. HSE Site Inspection
   2.2. Quality Site Inspections
      2.2.1. Audit
      2.2.2. Defects Inspection
   2.3. On-boarding and Training
3. COMPLETION ITEMS
   3.1. Testing

By this process, fragmenter 64 eventually stores all the required explicit and derived tasks 84a, 84b to memory 28.

In addition, allocator and releaser 68 (both discussed further below) samples explicit tasks 84a as they are completed and generate derived tasks 84b for quality assurance.

Table 1 is an example of the output of fragmenter 64, tabulating Network Element type, Spatial Reference, Work Item No., Work Item (SoR) Description, Quantity and Predecessors.

Aggregator 66 logically groups like tasks 84a, 84b into jobs 102 based as desired on any one or more of:
i) Collective duration,
ii) Location,
iii) Skill or capability requirements, and
iv) Specific interest.

This allows, for example, allocator and releaser 68 (described below) to allocate suitable tasks together for greater efficiency.

TABLE 1
Exemplary Output of Fragmenter 64

| Task | Network | | Work | Work Item (SoR) | | | |
|---|---|---|---|---|---|---|---|
| ID | Element | Spatial Ref | item # | Description | | Quantity | Predecessors |
| 001 | duct-AB | lat/long | 7HOB-07-01 | Directional | 02-02-02- | 50 m | None |
| | | | | Boring | 01 | | |
| 002 | | | 7HOB-07-02 | Cable | 03-03-01- | 50 m | None |
| | | | | Hauling | 01 | | |
| 003 | duct-BC | id?lat/long? | 7HOB-07-03 | Open | 02-02-01- | 100 m | None |
| | | | | Trenching | 01 | | |
| 004 | | | 7HOB-07-04 | Re- | 02-06-02- | 30 m² | 003 |
| | | | | instatement | 01 | | |
| 005 | | | 7HOB-07-05 | Cable | 03-03-01- | 100 m | 003 |
| | | | | Hauling | 01 | | |
| 006 | pit-A | id?lat/long? | 7HOB-07-06 | Pit | 02-03-01- | 1 | 003 |
| | | | | Installation | 01 | | |
| 007 | pit-B | id?lat/long? | 7HOB-07-07 | Pit | 02-03-01- | 1 | 002, 003 |
| | | | | Installation | 02 | | |
| 008 | pit-C | id?lat/long? | 7HOB-07-08 | Pit | 02-03-01- | 1 | 001, 002 |
| | | | | Installation | 03 | | |
| 009 | jointB | id?lat/long? | 7HOB-07-09 | Joint | 06-01-03- | 2 | 005 |
| | | | | enclosure | 05 | | |
| | | | | cable | | | |
| | | | | preparation | | | |
| 010 | jointB | id?lat/long? | 7HOB-07-10 | Joint | 06-01-01- | 1 | 009 |
| | | | | enclosure | 01 | | |
| | | | | installation | | | |
| 011 | Splice- | id?lat/long? | 7HOB-07-11 | Splicing | 06-06-01- | 48 | 010 |
| | jointB | | | | 03 | | |

### i) Collective Duration

If aggregator 66 is controlled to base aggregation on task size, aggregator 66 outputs jobs 102 no greater than the amount of work that a typical work crew for that task can complete in a day (or other stipulated work period, as appropriate).

### ii) Location

Aggregator 66 provides two levels of aggregation by location, collocation grouping and proximity grouping:
Collocation grouping: in some cases, plural assets 82 (such as cables) can be installed together (such as into a single duct); in such cases, the explicit tasks 84a arising from those assets 82 (e.g. two instances of cable hauling) can be grouped so as be performed simultaneously. Blueprinter 62 detects collocatable tasks in design 80 and groups them into jobs 102, as discussed further below, but with the tasks so grouped remaining independent but tagged with a unique job ID that enables any member of a respective job to be identified.
Proximity grouping: aggregator 66 group tasks into jobs that are physically close. In the example of a telecommunications network design, aggregator 66 the network hierarchy defined in design 80 to group such physically close tasks. The meaning of “physically close” will depend on the nature of the design, but will be apparent to the skilled person and/or implicit in the design 80. Thus, in the exemplary design 90, the smallest area in the network architecture is approximately 1 km² so aggregator 66 aggregates plural tasks within each cell of that size in design 80. (Optionally, aggregator 66 may then aggregate any previously unaggregated tasks by performing the same process but with a larger grid that, in the telecommunications network example, comprises cells of approximately 8 km².) This approach employs cell size as a proxy for travel time between tasks.

If tasks are to be aggregated on the basis of location and size, but jobs formed by aggregator 66 according to location aggregation exceed a day's work, aggregator 66 instead aggregates by location then outputs plural jobs 102 each of no greater than a day's size.

iii) Skill or Capability Requirements

If aggregator 66 is configured to base aggregation on architecture, aggregator 66 identifies tasks 84a, 84b that must be completed as a group before the commencement of the next activity involving that group. Aggregator 66 aggregates those tasks into a job (or possibly jobs if size is also to be considered).

### iv) Specific Interest

Aggregator 66 may be configured to base aggregation on one or more specific interests. For example, management may want to specifically track every major joint splicing activity separately or every single bore activity separately, regardless of size, location and architecture. In such cases, aggregator 66 outputs jobs 102 based on such tasks that maintain the geospatial information at the task level.

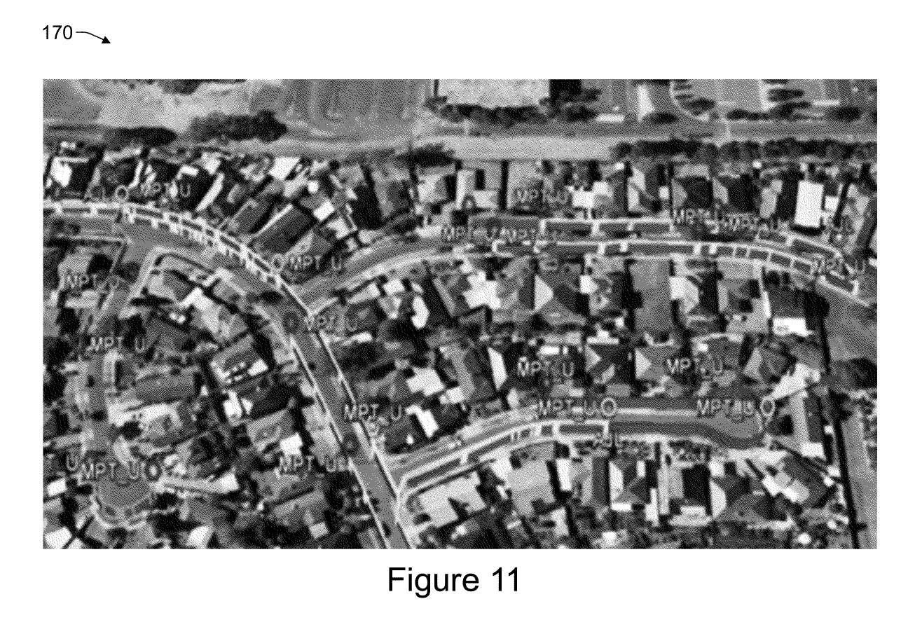

Once jobs 102 have thus been generated by blueprinter 62, blueprinter 62 can be controlled to output (via display 14 or printer 46, or in electronic form via network card 32) any one or more of jobs 102 for inspection, as a spreadsheet detailing all aspects of the respective job or jobs. Blueprinter 62 can also be controlled to pass job data to geospatial output generator 67, which is configured to convert job data (and any other geospatially tagged data generated by system 10) into KML for output (again, via display 14 or printer 46, or in electronic form via network card 32) in geospatial form suitable for superposition on (or already superimposed on) a map. An example of the output of geospatial output generator 67 is shown in FIG. 11; FIG. 11 depicts work order data (rather than job data) as processed by geospatial output generator 67, but each work order comprises one or more jobs 102 so the output of geospatial output generator 67 will be comparable in those instances.

Blueprinter 62 processes the approved construction design and logically splits, locates, sequences and values the labour and materials required by jobs 102 to deploy design 80, in accordance with Schedule of Rates and Material Supply agreements with respective contractors. Blueprinter 62 generates and outputs what is termed a “blueprint”, comprising a task dependency graph comprising nodes and connectors. Each node represents one of jobs 102 and the connectors connect each task to its predecessors/successors. The details of each job 102 include, in this example, the relevant network object, location in both spatial coordinates and street address, task details, state information (un-allocated, allocated, released, complete), predecessor jobs and connection dependency. Connection dependency is a parameter indicating the count of all connections (based on one connection per premises to be connected to the telecommunications network, though more than one is also possible) that depend on the task completion.

Thus, the blueprint is a logically linked representation of all jobs 102 required to construct the design 80, based on precedence and hierarchy. It does not include calculated or assumed durations of the jobs 102, so it does not constitute a schedule of work with respect to time. The blueprint does, however, provide the framework for the separate determination of a works schedule when resource, progress and productivity considerations are applied to it.

Blueprinter 62 stores and maintains the task dependency graph in memory 28 in the form of a job dependency matrix 104, which can—if desired—be exported to a .CSV file in which each row represents a job 102, and each job maintains an index to the predecessors.

Allocator and releaser 68 allocates qualified contractors to the jobs contained in the blueprint to push contractors' WMSs to issue orders to labour resources and/or material suppliers. It should be noted that, herein, the term ‘contractor’ is used to refer to any party that will actually do the work indicated in one or more of the jobs 102, though these parties may in some or all cases be individuals or teams, employees or otherwise and may not be strictly a ‘contractor.’

To facilitate the functions performed by allocator and releaser 68, memory 28 also includes a task-contractor matrix 106, which includes for each task that may arise from implementation of the design 80 a list of one or more approved contractors. The effectiveness of allocator and releaser 68 depends on the accuracy and currency of the task-contractor matrix 106 with regards to the characteristics of each contractor (including relevant capabilities, capacities, productivity, quality and price) and hence its fitness to implement a respective job.

Allocator and releaser 68 interfaces via WMS interface 78 with one or more WMSs that contain resource data (such as capability, capacity and price per region), using that information, filters tasks and contractors by required skill set (e.g. trenching, cable hauling, fibre splicing, test), and then considers each set independently.

Allocator and releaser 68 then generates job rankings of jobs 102 based on the mutual connection dependency (specified in job dependency matrix 104 for each job 102), the Area Completion (whereby jobs 102 in areas that are close to completion are given a higher ranking), and the contractor dependency (whether the task is blocking a dependent task which in turn is allocated to a contractor that has exhausted its ticket list, to minimize the time that contractors are idle), and hence optimises the implementation of design 80. To facilitate this process, allocator and releaser 68 performs this role each day based on data indicating cumulative progress to close of business of the respective previous day, this data being received from the WMSs of the contractors via WMS interface 78. Whether a job 102 is close to completion is determined by allocator and releaser 68 by determining the number of incomplete tasks for an Area; allocator and releaser 68 gives an Area with fewer incomplete tasks a higher priority and hence ranking.

Allocator and releaser 68 maintains a view of the contractor capacity and then allocates high ranking tickets to contractors until their capacity is reached or the set of tickets is exhausted. High ranking tickets with all predecessors completed are released. It should be noted that, in allocating a ticket, allocator and releaser 68 informs a contractor's WMS, via WMS interface 78, that the contractor has been given work that will be released at some time in the future. When releasing a ticket, allocator and releaser 68 sends release data to the contractor's WMS, via WMS interface 78, indicating that the work covered by a previously allocated ticket must be completed within a timeframe indicated in that release data. That is, “releasing” a ticket involves tagging the ticket as “active” and pushing data to the respective WMS to indicate that the tasks covered by that ticket have been activated, allocated and should be completed in the stipulated timeframe.

As mentioned above, allocator and releaser 68 uses WMS interface 78 to exchange information with external WMSs. WMS interface 78 allows allocator and releaser 68 to interrogate WMS resource databases of, for example, accredited external contractors that—in due course—will do the work specified in jobs 102, select such contractors based on predefined selection criteria, allocate one or more jobs 102 to such contractors and then uses WO generator 72 (discussed further below) to generate Work Order with corresponding WO numbers for the respective jobs 102.

Allocator and releaser 68 endeavors to fully allocate all jobs relevant to a defined component of the design 80. Allocator and releaser 68 also uses relevant historical (or globally averaged) contractor productivities to determine both the expected duration and approximate timing of each Work Order. In doing so, a future work commitment to the contractor is determined.

The allocation criteria employed by allocator and releaser 68 include:
Accredited WI capability: the contractors that have the necessary confirmed skillset at the WI level (specified in task-contractor matrix 106).
Total and Regional Capacity assessment: remaining capacity, based on total capacity (of all contractors and plant) versus WOs already allocated.
Productivity evaluation: using productivities calculated from those jobs 102 completed to date, prioritize contractors with greater productivity. Productivity is derived from the average time the respective contractors have taken to close like WOs in the WMS (i.e. from activation to completion). Productivity is thus continually updated by allocator and releaser 68, and stored in contractor-productivity matrix 108. (In an alternative embodiment, allocator and releaser 68 determines contractor productivity based on like tasks 84a, 84b.)
Quality Rating: on a quality rating within the WMS resource database.
Price: at the WI level, and in accordance with the Schedule of Rates of that contractor.
Pre-commitment: there may be some standing commitments for particular resources that have already been committed to particular jobs 102 in specific regions

Thus, allocator and releaser 68 is able to compare the Blueprint Sell price to the Allocated buy price at the WI level.

The expected remaining programme duration for the allocated works can then be calculated based on the total time determined from the productivities of the contractors allocated in accordance with job dependency matrix 104. This derived programme duration can be represented by:

ProjDuration=Blueprint×Resources@Productivities

If the scope of the required work remains unchanged (i.e. the job dependency matrix 104 is fixed), the project duration is dependent on contractor numbers and their productivities. Allocator and releaser 68 determines the effect of this dependency, and allows the programme duration to be controlled by allocating jobs to those contractors that have available capacity and by prioritizing more productive contractors.

Advantageously, allocator and releaser 68 also determines if there are insufficient contractors in a particular region to complete the jobs 102 for that region in an acceptable time.

Allocator and releaser 68 also outputs reports on how completely it has been able to allocate all remaining jobs 102 to available contractors; the inability of allocator and releaser 68 to do so completely indicates a likely contractor shortage at a potentially detailed level.

As mentioned above, productivity is treated by allocator and releaser 68 as the time it takes to carry out and complete a job once it has been released by the WMS. The time to complete a job is a function of the contractors applied to it and their productivities.

Allocator and releaser 68 uses the capacity of the contractors and their (historic) productivities and a predetermined utilisation factor, and packages the jobs 102 into WOs in accordance with the job dependency matrix 104. The utilisation factor is the minimum release commitment that is made with the respective contractor. For example, if a contractor has the capacity to deploy ten crews then, with an agreed utilisation factor of 70%, allocator and releaser 68 will release enough work to keep at least seven crews busy each week (calculated over a week).

The time windows in which allocator and releaser 68 allocates jobs and monitors parameters such as productivities is configurable, and may be selected to be—for example—daily, weekly or monthly. The finer the timing the more opportunity for optimisation. Allocator and releaser 68 also enables the contractors to plan material management and inventory with a higher level of certainty.

Allocator and releaser 68 includes a Scheduler (not shown) that allows a user manually to enter the effects of problems into the allocation/activation process, such as unusual work hours constraints, productivity limitations and the like.

The contractors' WMSs can monitor the progress of WOs including their status (viz. open or complete) at sub-item levels. Allocator and releaser 68 can additionally monitor progress of the works both logically and geospatially. Allocator and releaser 68, using job dependency matrix 104 and real-time WO progression at the WI level, determines progress at the asset level.

Once WOs have been raised by allocator and releaser 68 (in the allocation process), they are converted into active orders by allocator and releaser 68 on a periodic (typically daily) basis. This release function of allocator and releaser 68 is, as discussed above, as follows:
1. allocator and releaser 68 receives updated progress status of WOs at the level of jobs 102 from the contractors' WMSs by interfacing via WMS interface 78 with the WMSs at regular intervals (e.g. daily, weekly or hourly) and receiving progress data.
2. allocator and releaser 68 processes the progress status with its scheduler 70, which optimises the schedule of all tasks (and subsequently of all remaining tasks, at the end of each work period, such as at the end of each day), by ranking jobs 102 based on progress at the end of each day in accordance with the optimisation criteria discussed above. Allocator and releaser 68 then releases for construction/implementation work orders allocated to the contractors that are ready to be deployed based on job dependency matrix 104, allocations, progress to date, current priorities, resource information and jeopardy flags.
3. The WMS of the contractor (such as a construction company) is then updated by allocator and releaser 68 with the optimised WOs schedule and the relevant WOs are released by the WMS.
4. On a daily basis, each contractor accesses its WMS to find which new WOs have been released by allocator and releaser 68 overnight.

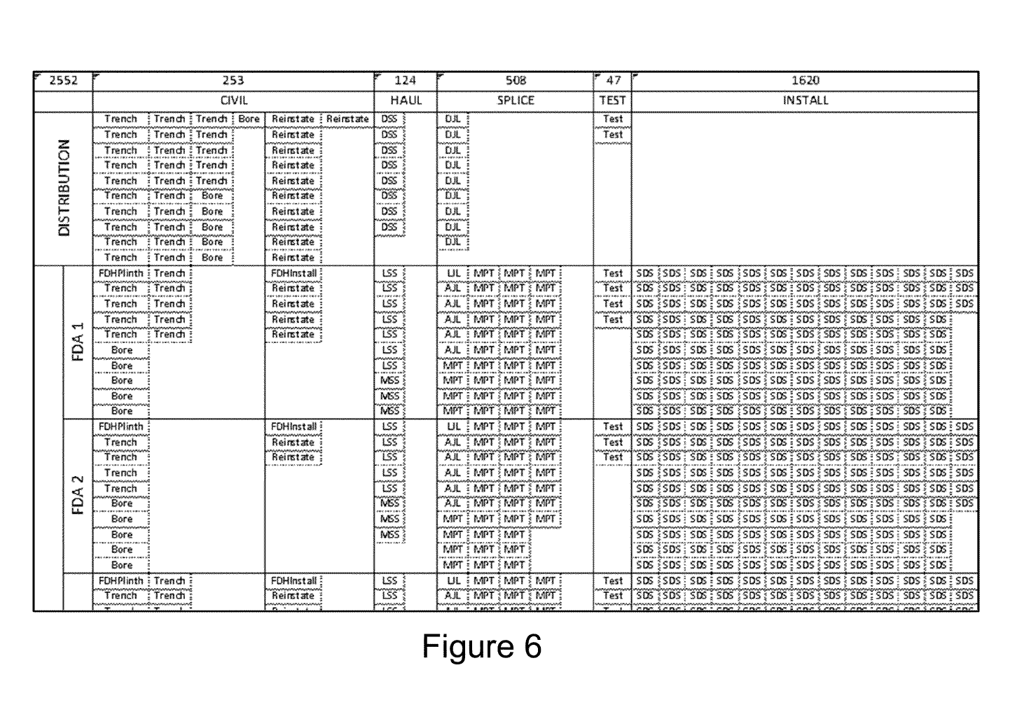

FIG. 6 is a schematic representation of the output of scheduler 70, showing different types of tasks (e.g. civil works, hauling tasks, splicing tasks and testing tasks) and their composition, together with an SDS (“Start & Finish Date”) for each task.

The release function of allocator and releaser 68 is expected to minimize waiting time and optimise the workflow progress. It also provides a systemic means of initiating derived tasks 84b with asset specific precision based on sampling rules and the like. For example, QA inspections of 3% of splices can be treated as derived tasks and managed with precision, certainty and randomness, based on progress, as an integral part of the implementation of design 80.

Additionally, as all tasks 84a, 84b (and hence jobs 102 and WOs) includes geospatial information, the effects of geographically specific factors (such as rainfall, snow, excessive heat, etc) may be seen in determined productivity, etc, and the potential effects of such factors may be taken into account by allocator and releaser 68.

WO generator 72 issues Work Orders (WOs), under the control of allocator and releaser 68, to a contractor. (WOs are also interchangeably referred to as Tickets of Work.) Allocator and releaser 68 controls WO generator 72 to generate a WO by sending WO generator 72 the requisite Work Order information including the applicable Allocated Jobs information. WO generator 72 applies SoR information specific to the respective contractor to the Allocated Jobs information received from allocator and releaser 68, and issues a suitable WO according to known WMS practices.

Progress monitor 74, via WMS interface 78, uses the WMS(s) of the contractor(s) to monitor the progress of the issued WOs at the Job and hence WI or task level. Through WMS interface 78, daily progress information is be fed back into allocator and releaser 68 so that allocator and releaser 68 can operate optimally in its utilisation of contractors and its prioritization of jobs 102, in order to optimize the progress of the required works.

In some installations the customer may not have a WMS. In these situations the function of the WMS and WMS interface are replaced by WO generator 72 and completer 76. Each day the set of assigned tasks produced by WO Generator 72 is written by WO Generator 72 to a CSV file. This information is forwarded to the contractors (whether via network card 32, in printed form via printer 46 or otherwise) and, at the close of business each day, the contractors provide system 10 (whether on-line or manually) with details of the WIs that have been completed, which are tagged as complete in completer 76.

An alternative processor 24′ for system 10 is illustrated schematically in FIG. 4B. Processor 24′ is generally identical with processor 24 of FIG. 4A, and like reference numerals have been used to identify like features. However, processor 24′ additionally includes a variation generator 71 controllable by the user to add, delete and alter tasks (including amending the type of a task, the size of a task and geospatial information associated with a task). Variation generator 71 is configured to respond to the addition, deletion or alteration of a particular task by correspondingly altering (such as in sequence and characteristics) any tasks associated with that particular task. For example, if a trench (for accommodating one or more cables) that runs down one side of a street is to be relocated to the other side of the street, variation generator 71 may be controlled to alter the trench so as to be located on the other side of the street; variation generator 71 would respond by deleting the trench (from the design) and creating one new trench on the opposite side of the street and two new street crossings to connect the ends of the new trench to the rest of the design. Alternatively, in this example but in a more manual approach, variation generator 71 may be controlled to delete the trench and subsequently to create the new trench on the opposite side of the street and the two street crossings. In both cases, variation generator 71 would also determine that longer cables would be required and send data to the other components of processor 24′ to make the required modifications.

Processor 24′ includes a jeopardy input 73 for receiving jeopardy data indicative of one or more factors that jeopardize the ability of a specific task to be commenced, thereby identifying geospatially tasks for consideration by scheduler 70. This enables the geospatial data handling ability of system 10 to integrate delays at the task level in the scheduling of the work.

Processor 24′ also includes a defect rectifier 75 that is configured to receive defect identification data indicative of a defect in a specified asset 82, to identify which resource performed work on the specific asset using the geospatial data held by system 10, and to control work order generator 72 to generate one or more geospatially tagged defect rectification tasks 84a, 84b adapted to remediate or correct the defect.

This allows system 10 to automatically allocate and release the one or more defect rectification tasks to the appropriate resource, typically the resource that carried out the work in which the defect occurred.

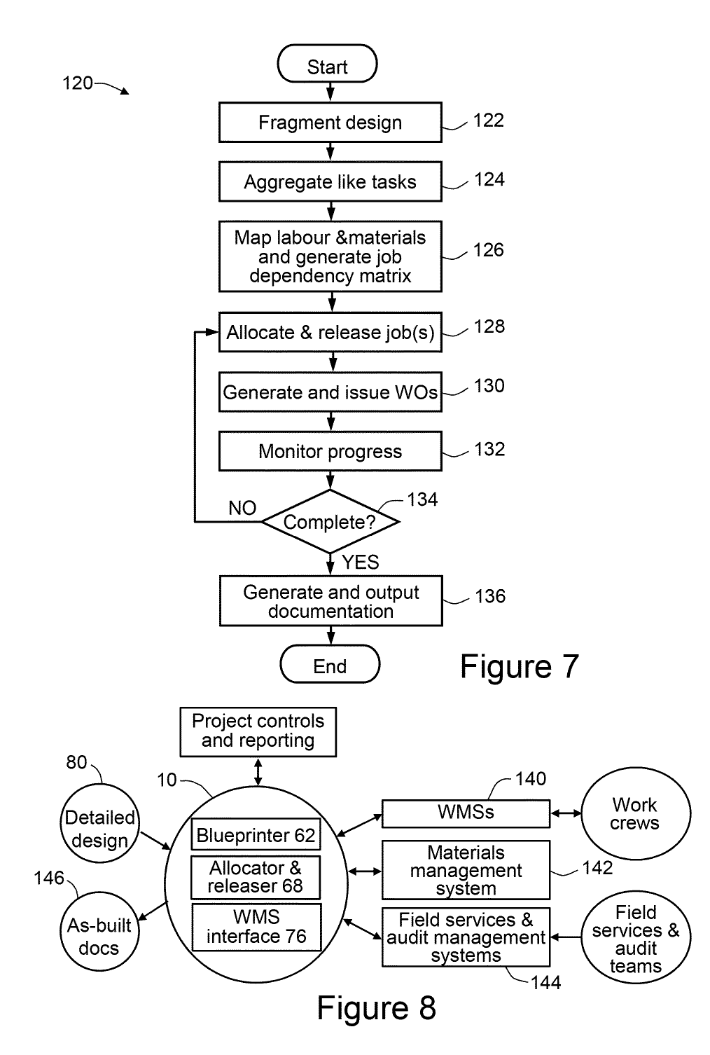

In summary, therefore, the process implemented by system 10 includes—as shown in flow diagram 120 of FIG. 7—at step 122 fragmenter 64 (of blueprinter 62) fragmenting design 80 into WIs 84 At step 124, aggregator 66 (of blueprinter 62) logically grouping like tasks 84a, 84b into jobs 102, while at step 126 blueprinter 62 maps the labour and materials required by jobs 102 to deploy design 80 and generates job dependency matrix 104.

At step 128, allocator and releaser 68 allocates and releases jobs (in groups of one or more), and at step 130 allocator and releaser 68 controls WO generator 72 to generate and issue Work Orders. At step 132, progress monitor 74 monitors progress and updates the relevant data. At step 134, system 10 periodically checks (such as once a day) whether the project has been completed; if not, processing returns to step 128 and continues, though now with updated data concerning jobs or tasks remaining, contractor productivity, etc. If, at step 134, system 10 determines that e project has been completed, processing continues at step 136 where system 10 generate and outputs documentation that documents the project as-built. Processing then ends.

System 10, as has been discussed above, includes a WMS interface 78 so that it can work with existing WMSs of outside parties. FIG. 8 is a simplified illustration of system 10 and its typical interaction, when in use, with outside entities such as contractors' WMSs 140, a materials management system 142 and field services & audit management systems 144. FIG. 8 also depicts the principal input to system 10 (the detailed design 80) and ‘as-built’ documentation 146.

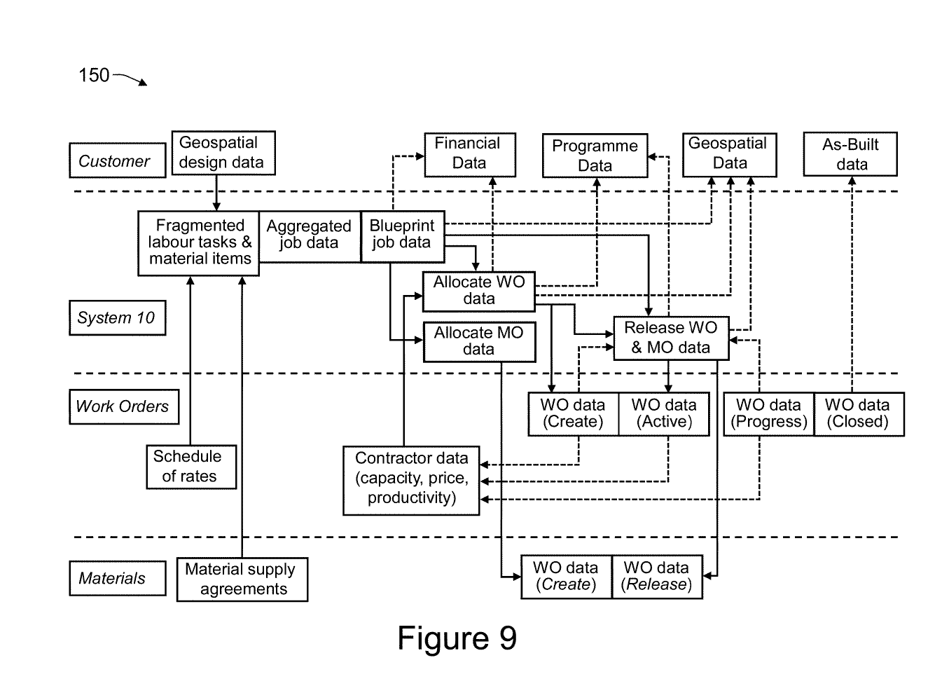

FIG. 9 is a schematic data flow diagram 150 for the operation of system 10 and its interaction with customers and contractors (via WOs). As indicated, the geospatial integrity at the task and item level is maintained end-to-end.

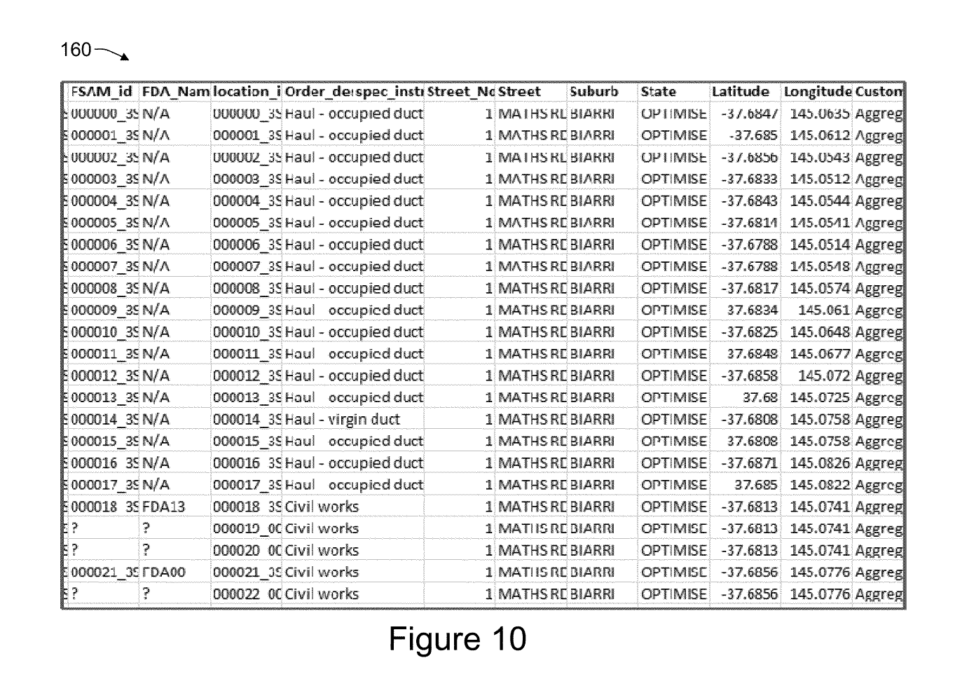

FIG. 10 is an example 160 of detailed work order data outputted by system 10 (in the form of job dependency matrix 104 outputted as a .CSV file), for the example of a design 80 comprising a telecommunications network. FIG. 11 shows the corresponding geospatial work order data (comprising one or more jobs 102) outputted by geospatial output generator 67 of system 10 in KML, superimposed on an aerial photograph of the area in which those WOs are to be implemented.

Thus, this embodiment addresses—at least to some extent—problems such as:
Lack of automation of the conversion of the design documents into spatially referenced work tasks leading to inconsistent and inefficient flow of work to the field resources.
Excessive highly manual tasks and interfaces and reliance on existing non-geospatial processes.
Resultant unsustainably low levels of workforce productivity and profitability.
Inability to determine detailed workforce planning against task based workload.
Resultant lack of willingness of Delivery Partners to invest in recruitment and training of the required workforce.

It should be understood to those persons skilled in the art of the invention that many modifications may be made without departing from the spirit and scope of the invention. It should also be understood that the reference to any prior art in this specification is not, and should not be taken as an acknowledgement or any form of suggestion that such prior art forms part of the common general knowledge in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1.-36. (canceled)

37. A system for designing or managing geospatial deployment, comprising:
an input for receiving design data indicative of a design that is to be deployed;
a fragmenter configured to fragment the design data into work items, each of the work items comprising one or more geospatially tagged tasks;
an aggregator configured to analyze the tasks and thereby identifying a type of each of the tasks, and to generate one or more geospatially tagged jobs each comprising one or more of the tasks such that each of the jobs comprises only tasks of like type;
an allocator configured to compare the jobs with a database of approved parties and characteristics of the respective parties, to identify for each of the jobs at least one of the approved parties that is fit to implement the respective jobs, and to allocate one or more of the jobs to one or more of the parties so identified;
a scheduler configured to determine an optimal implementation schedule of the jobs; and
a work order generator configured to generate geospatially tagged work orders according to the implementation schedule, each of the work orders being indicative of one or more of the jobs and of one of the parties so identified as fit to implement the respective one or more jobs and each of the work orders being suitable for transmitting to the party identified in the respective work order.

38. A system as claimed in claim 37, wherein the work order generator is configured to transmit each of the work orders to the party identified in the respective work order.

39. A system as claimed in claim 37, wherein the system comprises:
a releaser configured to transmit data to each of the parties identified in the work orders indicating that the respective work orders should be implemented; and/or
a progress monitor that receives implementation progress data from the parties identified in the work orders.

40. A system as claimed in claim 37, wherein the characteristics of the parties include a productivity value for each task provided by the respective parties.

41. A system as claimed in claim 37, wherein the system comprises a progress monitor that receives implementation progress data from the parties identified in the work orders, and wherein
the characteristics of the parties include a productivity value for each task provided by the respective parties, and the progress monitor determines productivity from the progress data for each of the parties identified in the work orders, and updates the productivity values; or
the allocator is adapted to allocate or re-allocate one or more of the jobs based additionally on the implementation progress data.

42. A system as claimed in claim 37, wherein the scheduler:
determines the implementation schedule according to criteria that comprise any one or more of: job dependency, state of completion, and capacity of implementation parties; or
determines the implementation schedule according to criteria that comprise any one or more of: job dependency, state of completion, and capacity of implementation parties, and determines or updates the implementation schedule periodically based on implementation progress.

43. A system as claimed in claim 37, wherein the system includes or is configured to access an element-to-task database, and the fragmenter identifies elements of the design in the design data and determines the tasks from the elements and the element-to-task database.

44. A system as claimed in claim 37, wherein the aggregator:
identifies a type of each of the tasks according to criteria that comprise any one or more of: task location and task capability requirements; or
generates the jobs such that each of the jobs once generated has an expected duration that can be accommodated by a predefined work period.

45. A system as claimed in claim 37, wherein the allocator allocates each of the jobs according to the one or more tasks constituting the respective jobs.

46. A system as claimed in claim 37, comprising a geospatial output generator configured to receive job data indicative of one or more of the jobs or work order data indicative of one or more of the work orders, and to generate data adapted for output or display as a map or superimposed on a map.

47. A system as claimed in claim 37, comprising a variation generator controllable to add, delete and alter tasks.

48. A system as claimed in claim 37, comprising a jeopardy input for receiving jeopardy data indicative of one or more factors that jeopardize the ability of a specific task to be commenced, thereby identifying geospatially tasks for consideration by the scheduler.

49. A system as claimed in claim 37, comprising a defect rectifier configured to receive defect identification data indicative of a defect in a specified asset, to identify which resource performed work on the specific asset, and to control the work order generator to generate one or more geospatially tagged defect rectification tasks adapted to remediate or correct the defect.

50. A computer-implemented method of designing or managing geospatial deployment, comprising:
electronically inputting design data indicative of a design that is to be deployed;
electronically fragmenting the design data into work items, each of the work items comprising one or more geospatially tagged tasks;
electronically analyzing the tasks and thereby identifying a type of each of the tasks;
electronically generating one or more geospatially tagged jobs each comprising one or more of the tasks such that each of the jobs comprises only tasks of like type;
electronically comparing the jobs with a database of approved parties and characteristics of the respective parties and identifying for each of the jobs at least one of the approved parties that is fit to implement the respective jobs;
electronically allocating one or more of the jobs to one or more of the parties so identified;
electronically determining an optimal implementation schedule of the jobs; and
electronically generating geospatially tagged work orders according to the implementation schedule, each of the work orders being indicative of one or more of the jobs and of one of the parties so identified as fit to implement the respective one or more jobs and each of the work orders being suitable for transmitting to the party identified in the respective work order.

51. A method as claimed in claim 50, comprising electronically transmitting each of the work orders to the party identified in the respective work order.

52. A method as claimed in claim 50, comprising transmitting data to each of the parties identified in the work orders indicating that the respective work orders should be implemented.

53. A method as claimed in claim 50, wherein the characteristics of the parties include a productivity value for each task provided by the respective parties.

54. A method as claimed in claim 50, wherein the method comprises electronically receiving implementation progress data from the parties identified in the work orders.

55. A method as claimed in claim 50 further comprising:
electronically receiving implementation progress data from the parties identified in the work orders and the characteristics of the parties include a productivity value for each task provided by the respective parties, and the method includes determining productivity from the progress data for each of the parties identified in the work orders and updating the productivity values; or
electronically receiving implementation progress data from the parties identified in the work orders and allocating or re-allocating one or more of the jobs based additionally on the implementation progress data.

56. A method as claimed in claim 50, including determining the implementation schedule according to criteria that comprise any one or more of: job dependency, state of completion, and capacity of implementation parties.

57. A method as claimed in claim 56, including determining or updating the implementation schedule periodically based on implementation progress.

58. A method as claimed in claim 50, wherein the method includes accessing an element-to-task database, identifying elements of the design in the design data and determining the tasks from the elements and the element-to-task database.

59. A method as claimed in claim 50, including identifying a type of each of the tasks according to criteria that comprise any one or more of: task location and task capability requirements.

60. A method as claimed in claim 50, including generating the jobs such that each of the jobs once generated has an expected duration that can be accommodated by a predefined work period.

61. A method as claimed in claim 50, including allocating each of the jobs according to the one or more tasks constituting the respective jobs.

62. A method as claimed in claim 50, comprising generating data adapted for output or display as a map or superimposed on a map from job data indicative of one or more of the jobs or work order data indicative of one or more of the work orders.

63. A method as claimed in claim 50, comprising electronically adding, deleting or altering tasks in response to user control.

64. A method as claimed in claim 50, comprising electronically receiving jeopardy data indicative of one or more factors that jeopardize an ability of a specific task to be commenced, thereby identifying geospatially tasks for consideration in determining the optimal implementation schedule.

65. A method as claimed in claim 50, comprising receiving defect identification data indicative of a defect in a specified asset, identifying which resource performed work on the specific asset, and controlling the work order generator to generate one or more geospatially tagged defect rectification tasks adapted to remediate or correct the defect.

66. A computer program product or computer-readable medium, comprising instructions that when executed by one or processors controls a computing device to implement the method of claim 50.
